(19) United States
(12) Patent Application Publication
(10) Pub. No.: US 2011/0084966 A1
(43) Pub. Date: Apr. 14, 2011

(54) METHOD FOR FORMING THREE-DIMENSION IMAGES AND RELATED DISPLAY MODULE

(76) Inventors: Meng-Chao Kao, Taipei City (TW); Tzu-Chiang Shen, Taoyuan County (TW)

(21) Appl. No.: 12/644,019

(22) Filed: Dec. 22, 2009

(30) Foreign Application Priority Data
Oct. 8, 2009 (TW) 098134090

(51) Int. Cl. G09G 5/02; G06T 15/50

(52) U.S. Cl. 345/426; 345/604

(57) ABSTRACT

An image-forming method includes inputting a color image, transforming the color image into a first grayscale image, reducing a first brightness range of the first grayscale image to a second brightness range, generating a grayscale gradient image corresponding to spatial distribution of the first grayscale image according to the first brightness range and the second brightness range, overlapping the first grayscale image having the second brightness range and the grayscale gradient image to generate a second grayscale image, generating a translation image according to the second grayscale image and the color image, and forming a three-dimension image according to the color image and the translation image.

### BACKGROUND OF THE INVENTION

1. Field of the Invention

The present invention relates to an image forming method and a related display module, and more specifically, to a method for forming three-dimension images and a related display module.

2. Description of the Prior Art

In general, three-dimension images are transmitted as left eye images and right eye images viewed by the left eye and the right eye, respectively. The images received by the two eyes are matched as three-dimension images with a depth of field according to a discrepancy between visual angles of the two eyes. Some common means utilized for generating three-dimension images include polarizing glasses, shutter glasses, an anaglyph, and an auto-stereoscopic display.

For the said means, generating left eye images and right eye images will be a necessary step. A common method for generating left eye images and right eye images involves calculating a translation of each pixel in a color image based on a depth map corresponding to the color image. Based on the translation of each pixel, multiple sets of color images, which correspond to the left eye and the right eye respectively, may be generated accordingly. However, in the prior art, the method for manufacturing a depth map usually has problems of complicated calculation and erroneous acquisition. For example, U.S. Pat. No. 20060232666 discloses that an edge of an object in an input image may be detected according to motion vectors, brightness values, or color values of the object in a prior frame and a current frame. In such a manner, a depth map is correspondingly generated based on the said edge detection result. However, in this method, erroneous acquisition usually occurs when detecting the edge of the object. This problem may not only result in a distorted depth map, but may also reduce the three-dimension image quality. Furthermore, another common method involves utilizing drawing software (e.g. Photoshop) to manually manufacture a depth map. Although a depth map based on this method may be manufactured with high accuracy, the related manufacturing process is time-consuming and strenuous.

### SUMMARY OF THE INVENTION

The present invention provides a method for forming three-dimension images, the method comprising inputting a color image; transforming the color image into a first grayscale image; reducing a first brightness range of the first grayscale image to a second brightness range; generating a grayscale gradient image corresponding to spatial distribution of the first grayscale image according to the first brightness range and the second brightness range; overlapping the first grayscale image having the second brightness range and the grayscale gradient image to generate a second grayscale image; generating a translation image according to the second grayscale image and the color image; and forming a three-dimension image according to the color image and the translation image.

The present invention further provides a display module for displaying three-dimension images, the display module comprising an input unit for inputting a color image; a grayscale transforming unit for transforming the color image into a first grayscale image; a brightness processing unit for reducing a first brightness range of the first grayscale image to a second brightness range; a grayscale-image generating unit for generating a grayscale gradient image corresponding to spatial distribution of the first grayscale image according to the first brightness range and the second brightness range and for overlapping the first grayscale image having the second brightness range and the grayscale gradient image to generate a second grayscale image; a translation-image generating unit for generating a translation image according to the second grayscale image and the color image; and a display unit for display a three-dimension image according to the color image and the translation image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a display module according to a preferred embodiment of the present invention.

FIG. 2 is a flowchart of a method for forming three-dimension images by the display module in FIG. 1.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . .”

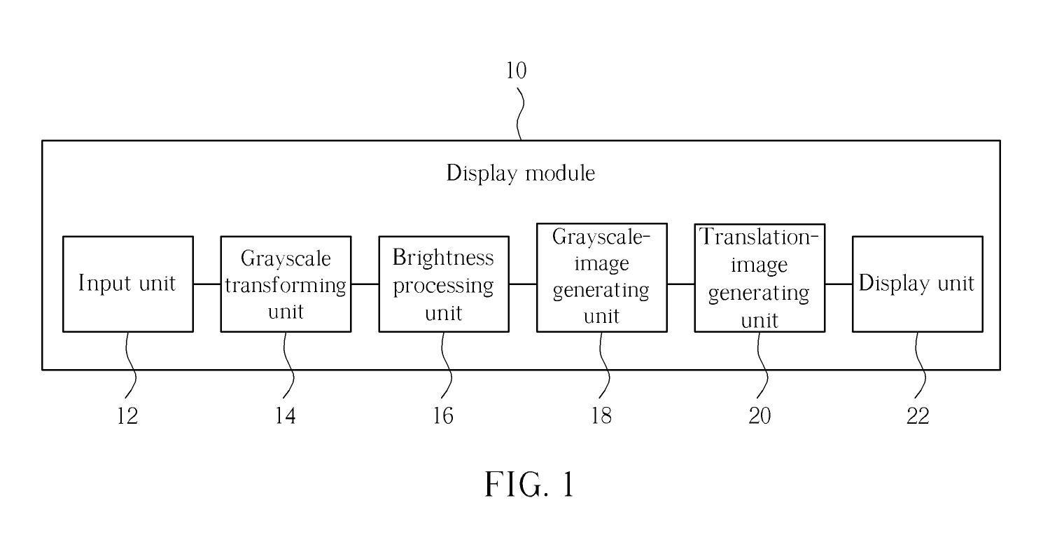

Please refer to FIG. 1, which is a functional block diagram of a display module 10 according to a preferred embodiment of the present invention. As shown in FIG. 1, the display module 10 includes an input unit 12, a grayscale transforming unit 14, a brightness processing unit 16, a grayscale-image generating unit 18, a translation-image generating unit 20, and a display unit 22. The input unit 12 is used for inputting a color image. In this embodiment, the input unit 12 is preferably a conventional signal inputting terminal, such as an RGB analogy terminal, a YPbPr component video connector, or an HDMI (High Definition Multimedia Interface) terminal. The grayscale transforming unit 14 is used for transforming the color image into a first grayscale image. The brightness processing unit 16 is used for reducing the brightness range of the first grayscale image and performing a contrast enhancement process on the first grayscale image having the said reduced brightness range. The grayscale-image generating unit 18 is used for generating a grayscale gradient image corresponding to spatial distribution of the first grayscale image and overlapping the first grayscale image and the grayscale gradient image to generate a second grayscale image. The translation-image generating unit 20 is used for generating a translation image according to the second grayscale image and the color image. The display unit 22 is used for displaying a three-dimension image according to the color image and the translation image. The display unit 22 is preferably an LCD (Liquid Crystal Display) screen.

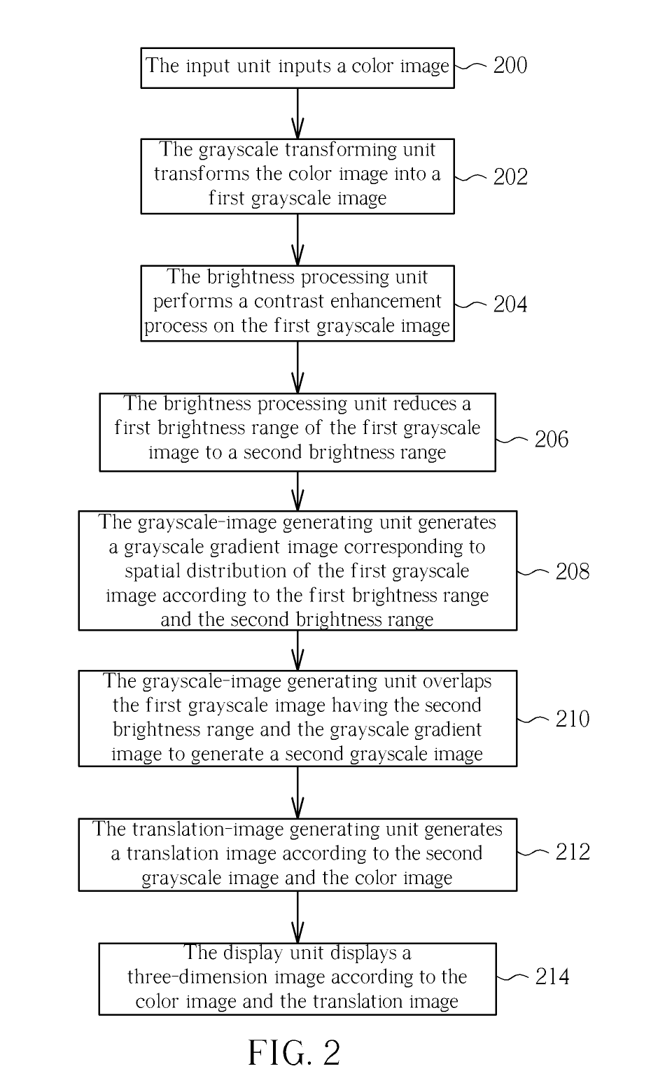

Next, please refer to FIG. 2, which is a flowchart of a method for forming three-dimension images by the display module 10 in FIG. 1. The method includes the following steps.

Step 200: The input unit 12 inputs the color image;

Step 202: The grayscale transforming unit 14 transforms the color image into the first grayscale image;

Step 204: The brightness processing unit 16 performs the contrast enhancement process on the first grayscale image;

Step 206: The brightness processing unit 16 reduces a first brightness range of the first grayscale image to a second brightness range;

Step 208: The grayscale-image generating unit 18 generates the grayscale gradient image corresponding to the spatial distribution of the first grayscale image according to the first brightness range and the second brightness range;

Step 210: The grayscale-image generating unit 18 overlaps the first grayscale image having the second brightness range and the grayscale gradient image to generate the second grayscale image;

Step 212: The translation-image generating unit 20 generates the translation image according to the second grayscale image and the color image;

Step 214: The display unit 22 displays the three-dimension image according to the color image and the translation image.

More detailed description for the said steps is provided as follows. First, as mentioned in Step 200 and Step 202, the color image is transmitted from the input unit 12 to the grayscale transforming unit 14. Subsequently, the grayscale transforming unit 14 may perform a grayscale transforming process on the color image. The said grayscale transforming process may be a grayscale transforming algorithm commonly seen in the prior art. For example, the grayscale transforming unit 14 may average a red color value, a green color value, and a blue color value of each pixel in the color image to generate a corresponding average value. Subsequently, the grayscale transforming unit 14 may set the average value as a brightness value of the pixel. As a result, the color image may be transformed into the first grayscale image correspondingly. Another example is provided as follows. The grayscale transforming unit 14 may also average a maximum value and a minimum value among a red color value, a green color value, and a blue value of each pixel to generate an average value, and then set the average value as a brightness value of the pixel. In other words, all methods commonly used for transforming color images into corresponding grayscale images may be applied to the present invention. As for which method is utilized, it depends on practical application of the display module 10.

After transforming the color image into the first grayscale image, the brightness processing unit 16 may sequentially perform the contrast enhancement process (Step 204) and a brightness-range reducing process (Step 206) on the first grayscale image. In the contrast enhancement process, for example, the brightness processing unit 16 may set the brightness values less than 64 as 0, and set the brightness values greater than 192 as 192. As for the brightness values between 64 and 192, the brightness processing unit 16 may respectively subtract 64 from these brightness values, and then multiply these brightness values by a specific value greater than 1 (e.g. 2) respectively. In such a manner, the purpose of expanding brightness variations between each pixel in the first grayscale image may be achieved accordingly after performing the said calculating steps. It should be noted that the contrast enhancement process utilized in Step 204 is not limited to the said process. For example, the brightness processing unit 16 may also perform a stepwise contrast enhancement process on different brightness distribution sections in the first grayscale image. Since this stepwise contrast enhancement process is commonly used in the prior art, related description is therefore omitted herein.

On the other hand, in the brightness-range reducing process, the brightness processing unit 16 may divide the original brightness range (i.e. the first brightness range mentioned in Step 206) of the first grayscale image by a specific value greater than 1 to generate the second brightness range. For example, it is assumed that the specific value is equal to 4 and the first brightness range of the first grayscale image is from 0 to 255. Thus, the brightness processing unit 16 may divide a brightness value of each pixel in the first grayscale image by 4, so as to reduce the brightness range of the first grayscale image from the first brightness range (0˜255) to the second brightness range (0˜63).

After expanding the brightness variations between each pixel in the first grayscale image and reducing the first brightness range of the first grayscale image to the second brightness range via the brightness processing unit 16, the grayscale-image generating unit 18 may generate the corresponding grayscale gradient image according to a subtraction result of the first brightness range and the second brightness range (Step 208). As mentioned above, the first brightness range is from 0 to 255 and the second brightness range is from 0 to 63. Thus, after subtracting the second brightness range from the first brightness range, the grayscale-image generating unit 18 may generate the grayscale gradient image having the brightness range from 0 to 192.

More detailed description for the grayscale gradient image is provided as follows. In general, in an image, its brightness distribution may be reversely proportional to its distance distribution therein. That is, the pixel at the bottom end of the image usually may have the maximum brightness value, and the pixel at the top end of the image may have the minimum brightness value. Thus, in this embodiment, the said grayscale gradient image may be set as a gradient image having decreasing brightness gradually from an image bottom end to an image top end. In addition, the said grayscale gradient image may also correspond to the spatial distribution of the first grayscale image. That is, the resolution of the grayscale gradient image is equal to that of the first grayscale image.

After generating the grayscale gradient image, the grayscale-image generating unit 18 may perform an image overlapping step (i.e. Step 210). In Step 210, the grayscale-image generating unit 18 may overlap the first grayscale image having the second brightness range and the said grayscale gradient image to generate the second grayscale image. More detailed description for Step 210 is provided as follows based on the said example. As mentioned above, the second brightness range is from 0 to 63, and the brightness range of the grayscale gradient image is from 0 to 192. In Step 210, the grayscale-image generating unit 18 may set the sum of the brightness value of each pixel in the first grayscale image and the brightness value of each pixel in the grayscale gradient image as a brightness value of each pixel in the second grayscale image. Thus, the second grayscale image may correspond to the color image, and the brightness range of the second grayscale image may be from 0 to 255.

After performing the said steps, the brightness value of each pixel in the second grayscale image may be regarded as a combined value of the brightness variable and the spatial variable of the color image. Thus, the second grayscale image may be used as a depth map for calculating the relative translations of the pixels in the color image. That is, after overlapping the grayscale gradient image and the first grayscale image to generate the second grayscale image by the grayscale-image generating unit 18, the translation-image generating unit 20 may generate at least one translation image according to the second grayscale image and the color image (Step 212), wherein the translation image has a translation relative to the color image. In such a manner, the color image and the translation image may be used as a set of images corresponding to the left eye and the right eye respectively.

Finally, after receiving the color image and the translation image, the display unit 22 may form and then display the corresponding three-dimension image (Step 214). The method for displaying the three-dimension image utilized in the display unit 22 may be a multiplexed two-dimension method. In general, the said multiplexed two-dimension method involves providing the user's left eye and right eye with planar images at different visual angles via the same display system, respectively. Subsequently, the said planar images at different visual angles may be matched as three-dimension images with a depth of field by vision persistence in the user's brain. The multiplexed two-dimension method may be divided into two types: spatial-multiplexed and time-multiplexed. In the spatial-multiplexed method, at least one set of images may be displayed on an LCD screen by an image-interweaving method. For example, pixel cells in an LCD screen may be divided into odd pixel cells and even pixel cells to form images respectively corresponding to the user's left eye and right eye. Subsequently, the said left eye images and right eye images are projected to the user's left eye and right eye respectively by a lenticular lens so that the user may view three-dimension images accordingly.

As for the said time-multiplexed method, it involves controlling a three-dimension image display apparatus to project images to a user's left eye and the user's right eye sequentially in turns. When image switching speed is fast enough, the said left eye images and right eye images may be matched as three-dimension images by vision persistence in the user's brain.

In summary, in Step 214, if the said spatial-multiplexed method is applied to the display unit 22, the display unit 22 may display the color image (e.g. being formed by odd pixel cells) and the translation image (e.g. being formed by even pixel cells) at a display speed of thirty frames per second, so that the user's left eye and right eye may view the color image and the translation image respectively. In such a manner, the user may view the three-dimension image matched by the color image and the translation image.

On the other hand, if the said time-multiplexed method is applied to the display unit 22, the display unit 22 may display the color image and the translation image sequentially in turns so that the user's left eye and right eye may view the color image and the translation image respectively. In this way, the user may also view the three-dimension image matched by the color image and the translation image. In the present invention, the display unit 22 preferably utilizes the said image-interweaving method to simultaneously display two sets of images, which are composed of the color image and the corresponding translation images, so that the three-dimension image may be formed accordingly.

It should be mentioned that Step 204 may be an optional step. That is, after the grayscale transforming unit 14 transforms the color image into the first grayscale image, the brightness processing unit 16 may directly reduce the first brightness range of the first grayscale image without performing Step 204. Furthermore, the brightness range of the first grayscale image and the brightness range of the grayscale gradient image are not limited to the brightness ranges mentioned in the said embodiment. For example, the brightness processing unit 16 may divide the first brightness range of the first grayscale image by 2 instead. Thus, the first grayscale image may have a brightness range from 0 to 127, and the grayscale gradient image may correspondingly have a brightness range from 0 to 128. In brief, as long as the maximum brightness value of the second grayscale image is less than 255, all related derivative variations for the brightness range of the first grayscale image and the brightness range of the grayscale gradient image may fall within the scope of the present invention.

Compared with the prior art, in which manufacturing of a depth map is time-consuming and strenuous, the present invention involves utilizing the said simple steps to generate a depth map quickly and accurately. In such a manner, via the said simple steps, the present invention may reduce the time needed for manufacturing a depth map. Furthermore, since each brightness value in the depth map is combined by the brightness variable and the spatial variable of the input color image, the present invention may also increase the accuracy of depth information provided from the depth map. Thus, the three-dimension image quality may be increased greatly.

Those skilled in the art will readily observe that numerous modifications and alterations of the device and method may be made while retaining the teachings of the invention.

What is claimed is:

1. A method for forming three-dimension images, the method comprising:
inputting a color image;
transforming the color image into a first grayscale image;
reducing a first brightness range of the first grayscale image to a second brightness range;
generating a grayscale gradient image corresponding to spatial distribution of the first grayscale image according to the first brightness range and the second brightness range;
overlapping the first grayscale image having the second brightness range and the grayscale gradient image to generate a second grayscale image;
generating a translation image according to the second grayscale image and the color image; and
forming a three-dimension image according to the color image and the translation image.

2. The method of claim 1, wherein transforming the color image into the first grayscale image comprises:
setting an average value of a red color value, a green color value, and a blue color value of each pixel in the color image as a brightness value of the pixel.

3. The method of claim 1, wherein reducing the first brightness range of the first grayscale image to the second brightness range comprises:
dividing the first brightness range of the first grayscale image by a specific value greater than 1 so as to generate the second brightness range.

4. The method of claim 1, wherein generating the grayscale gradient image corresponding to the spatial distribution of the first grayscale image according to the first brightness range and the second brightness range comprises:
generating the grayscale gradient image corresponding to the spatial distribution of the first grayscale image according to a difference between the first brightness range and the second brightness range.

5. The method of claim 1, wherein generating the grayscale gradient image corresponding to the spatial distribution of the first grayscale image according to the first brightness range and the second brightness range comprises:
generating the grayscale gradient image having decreasing brightness gradually from an image bottom end to an image top end according to the first brightness range and the second brightness range.

6. The method of claim 1 further comprising:
performing a contrast enhancement process on the first grayscale image.

7. The method of claim 1, wherein forming the three-dimension image according to the color image and the translation image comprises:
forming the three-dimension image by an image-interweaving method.

8. A display module for displaying three-dimension images, the display module comprising:
an input unit for inputting a color image;
a grayscale transforming unit for transforming the color image into a first grayscale image;
a brightness processing unit for reducing a first brightness range of the first grayscale image to a second brightness range;
a grayscale-image generating unit for generating a grayscale gradient image corresponding to spatial distribution of the first grayscale image according to the first brightness range and the second brightness range and for overlapping the first grayscale image having the second brightness range and the grayscale gradient image to generate a second grayscale image;
a translation-image generating unit for generating a translation image according to the second grayscale image and the color image; and
a display unit for displaying a three-dimension image according to the color image and the translation image.

9. The display module of claim 8, wherein the grayscale transforming unit is used for setting an average value of a red color value, a green color value, and a blue color value of each pixel in the color image as a brightness value of the pixel.

10. The display module of claim 8, wherein the brightness processing unit is used for dividing the first brightness range of the first grayscale image by a specific value greater than 1 so as to generate the second brightness range.

11. The display module of claim 8, wherein the grayscale-image generating unit is used for generating the grayscale gradient image corresponding to the spatial distribution of the first grayscale image according to a difference between the first brightness range and the second brightness range.

12. The display module of claim 8, wherein the grayscale-image generating unit is used for generating the grayscale gradient image having decreasing brightness gradually from an image bottom end to an image top end according to the first brightness range and the second brightness range.

13. The display module of claim 8, wherein the brightness processing unit is used for performing a contrast enhancement process on the first grayscale image.

14. The display module of claim 8, wherein the display unit is used for displaying the three-dimension image by an image-interweaving method.

15. The display module of claim 8, wherein the display unit is a LCD (Liquid Crystal Display) screen.

16. The display module of claim 8, wherein the input unit is an image-signal terminal.
